(19) United States
(12) Patent Application Publication
(10) Pub. No.: US 2026/0113242 A1
(43) Pub. Date: Apr. 23, 2026

(54) METHOD FOR OPERATING A VIRTUALIZED RADIO ACCESS NETWORK, VRAN, AND CONTROL SYSTEM IN A VRAN

(71) Applicant: NEC Laboratories Europe GmbH, Heidelberg (DE)

(72) Inventors: Josep Xavier SALVAT LOZANO, Heidelberg (DE); Guillermo ENCINAS LAGO, Heidelberg (DE); Xavier COSTA-PÉREZ, Heidelberg (DE)

(21) Appl. No.: 19/475,760

(22) PCT Filed: Dec. 27, 2023
(86) PCT No.: PCT/EP2023/087863

§ 371 Date: Oct. 16, 2025

(30) Foreign Application Priority Data
Apr. 20, 2023 (EP) 23168986

(51) Int. Cl. H04L 41/0895; H04B 7/04; H04B 17/309; H04L 43/12

(52) U.S. Cl. CPC H04L 41/0895; H04B 7/04013; H04B 17/346; H04L 43/12

(57) ABSTRACT

A method of operating a virtualized radio access network (VRAN), where a radio cell of the vRAN includes one or more virtualized base stations (vBSs) serving a number of users located within a coverage area of the radio cell, and at least one reconfigurable intelligent surface (RIS). The vBSs include radio units (RUs), and distributed units (DUs), where each RU is associated with at least one DU, and where the DUs are deployed in an edge computing device sharing the computing device's available computing resources. The method includes determining, using a controller, configuration parameters of the at least one RIS in terms of gain and/or phase of reflective elements of the RIS that minimize a computing overhead of the DUs deployed in the edge computing device. The method can use Artificial Intelligence (AI) and Machine Learning (ML) operations for optimizing computing consumption of a vRAN with improved decision making.

### CROSS REFERENCE TO RELATED APPLICATIONS

This application is a U.S. National Phase application under 35 U.S.C. § 371 of International Application No. PCT/EP2023/087863, filed on Dec. 27, 2023, and claims benefit to European Patent Application No. 23168986.0, filed on Apr. 20, 2023. The International Application was published in English on Oct. 24, 2024 as WO 2024/217718 A1 under PCT Article 21(2).

### FIELD

The present invention relates to a method of operating a virtualized radio access network (vRAN) and a control system in a vRAN.

### BACKGROUND

RAN virtualization (vRAN) is a crucial aspect of future mobile architectures, as it enables running the Base Station (BS) on virtualized infrastructure rather than on dedicated hardware. This breaks the traditional vendors' lock-in and opens the RAN market to innovation and new players. Additionally, RAN virtualization enables the deployment of multiple virtual RANs on a single physical location, improving network efficiency and reducing costs.

Unfortunately, there is a high price to be paid in terms of computing overhead usage due to non-ideal isolation between virtualized Base Stations (vBSs) when deploying multiple of them into the same infrastructure. Specifically, sharing different non-ideally isolated computing resources across different vBSs leads to frequent resource contentions, which result in service degradation. This is the ‘noisy neighbours’ problem and arises from overusing shared resources. Some studies report degradation of up to 40% (for reference, see A. Tootoonchian et al.: “Resq: Enabling slos in network function virtualization”, 15^{th} {USENIX} Symposium on Networked Systems Design and Implementation ({NSDI} 18), 2018, or A. Manousis et al.: “Contention-aware performance prediction for virtualized network functions”, Proceedings of the Annual conference of the ACM Special Interest Group on Data Communication on the applications, technologies, architectures, and protocols for computer communication, 2020). The noisy neighbours problem negatively affects energy consumption, as it is directly proportional to computing usage. In addition, it negatively impacts the latency as resource contention increases the number of computing cycles used to access the resources.

Common mechanisms to mitigate the noisy neighbour's problem include pinning the vBSs processes to different computing cores or using tools such as Intel CAT to allocate the different lines of the cache memory used by the different computing cores. However, as computing resources at the network edge are very limited, large-scale deployments might not be able to fully isolate the different processes as they might have more processes than computing cores or cache lines. Thus, operators might be forced to handle the noisy neighbour effect to some extent.

Accordingly, there may be a desire for an improved concept for effectively mitigating the noisy neighbour's problem in an edge computing device of a vRAN.

### SUMMARY

In an embodiment, the present disclosure provides a method of operating a virtualized radio access network (VRAN), where a radio cell of the vRAN includes one or more virtualized base stations (vBSs) serving a number of users located within a coverage area of the radio cell, and at least one reconfigurable intelligent surface (RIS). The vBSs include radio units (RUs), and distributed units (DUs), where each RU is associated with at least one DU, and where the DUs are deployed in an edge computing device sharing the computing device's available computing resources. The method includes determining, using a controller, configuration parameters of the at least one RIS in terms of gain and/or phase of reflective elements of the RIS that minimize a computing overhead of the DUs deployed in the edge computing device. The method can use Artificial Intelligence (AI) and Machine Learning (ML) operations for optimizing computing consumption of a vRAN with improved decision making.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram illustrating the uplink computing usage of a vBS as a function of the received traffic;

FIG. 2 is a diagram illustrating the downlink computing usage of a vBS as a function of the received traffic;

FIG. 3 is a schematic view illustrating an exemplary system model considered in the present disclosure;

FIG. 4 is a schematic view illustrating a system for minimizing the computing consumption in vRAN using RIS according to an embodiment of the present disclosure;

FIG. 5 is a schematic view illustrating functional blocks of a controller in case of one available RIS according to an embodiment of the present disclosure; and

FIG. 6 is a schematic view illustrating functional blocks of a controller in case of two or more available RIS according to an embodiment of the present disclosure.

### DETAILED DESCRIPTION

In accordance with the present disclosure, an embodiment includes a method of operating a virtualized radio access network (vRAN), wherein a radio cell of the vRAN comprises one or multiple virtualized base stations (vBSs) serving a number of users located within the coverage area of the radio cell, and at least one reconfigurable intelligent surface (RIS), and wherein the vBSs include radio units (RUs) and distributed units (DUs), wherein each RU is associated with at least on DU and wherein the DUs are deployed in an edge computing device sharing the device's available computing resources, the method comprising: using a controller to determine configuration parameters of the at least one RIS in terms of gain and/or phase of the reflective elements of the RIS that minimize the computing overhead of the DUs deployed in the edge computing device.

Furthermore, an embodiment of the present disclosure includes a control system in a virtualized radio access network (vRAN), wherein a radio cell of the vRAN comprises one or multiple virtualized base stations (vBSs) serving a number of users located within the coverage area of the radio cell, and at least one reconfigurable intelligent surface (RIS), and wherein the vBSs include radio units (RUs) and distributed units (DUs), wherein each RU is associated with at least on DU and wherein the DUs are deployed in an edge computing device sharing the device's available computing resources, the control system comprising a controller that is configured to set configuration parameters of the at least one RIS in terms of gain and/or phase of the reflective elements of the RIS that minimize the computing overhead of the DUs deployed in the edge computing device.

Embodiments of the present disclosure provide a method that uses RISs surfaces deployed within a coverage area of a radio cell to improve the SNR and consequently the (Modulation and Coding Scheme) MCS of UEs located in the cell's coverage area selectively to reduce the effect of the noisy neighbors problem caused by deploying multiple vBSs in the same computing platform. Embodiments of the present disclosure provide a controller that is configured to adapt the configuration parameters of (a number of) Reconfigurable Intelligent Surfaces (RISs), i.e., the gain and/or phase of their reflective elements, in such a way that the computing consumption of a vRAN, which is providing service to the area where the RISs are deployed, is optimized. It has been recognized that by reducing the total computing overhead of an edge computing device, in which the DUs are deployed sharing the device's available computing resources, the noisy neighbours problem can be mitigated. According to embodiments, the controller may be implemented as an AI-driven controller.

According to embodiments of the present disclosure, the controller is configured to reduce the computing consumption of the different DUs deployed in the edge computing device. The DU instances deployed in the edge computing device, e.g. an edge cloud server, provide (5G) connectivity to the different users of a cell. In this context, it is important to note that the different DUs must complete the FEC (Forward Error Correction) operations with very tight time constraints. When deploying multiple of them into the same infrastructure, sharing different non-ideally isolated computing resources across different DUs leads to frequent resource contentions, resulting in service degradation. Thus, embodiments of the present disclosure minimize the computing overhead caused by the contentions of the different DUs, in particular in large-scale deployments. The controller may be configured to decide the RIS configurations that minimize the computing overhead due to the noisy neighbors problem of the different DUs deployed. For instance, the controller may optimize jointly the RIS configuration of different deployed RIS which minimize the computing consumption.

In some examples, it may be provided that the controller uses contextual information about the users to discover which users are generating the highest traffic loads and/or which users share similar channels due to their spatial distribution within the coverage area of the radio cell. Based on this information, the controller may determine configuration parameters of the at least one RIS to improve selectively the signal-to-noise ratio (SNR) of the respective users. In this context, it is important to note that an improved SNR enables a user to operate with a higher MCS, which, in turn, would result in a decrease of the computing overhead of the DUs deployed in the edge computing device, thereby contributing to alleviate the ‘noisy neighbours’ problem.

In some examples, it may be provided that the controller generates a context vector for each user located in the cell's coverage area, wherein the context vector is based on a set of metrics collected for the respective user from the DUs deployed. For instance, the metrics may include a current SNR the respective user experiences in the uplink and in the downlink. Additionally or alternatively, the metrics may include traffic demands of the respective user, and/or the position of the respective user within the cell. In this regard, it may be provided that the control system comprises a metrics agent deployed on the edge computing device, wherein the metrics agent may be configured to gather a predefined set of different metrics from the DUs and/or the users and to save the gathered metrics into a metrics database.

According to an example, the controller may be configured to apply a context-embedding technique (such as a relation network) to embed the context vector into a fixed dimension space. The controller may then use the contextual information of the context vector as input to learn the latent relationship between the context and the computing overhead of the DUs deployed in the edge computing device.

In an example, the control system may further comprise monitoring probes deployed in the cell's coverage area. The monitoring probes, which may be deployed by different operators, may be configured to provide the controller with additional or alternative contextual information about an area within the cell's coverage area where different DUs give coverage. The controller may also generate a context vector based on contextual information retrieved from such monitoring probes. This contextual information can also be embedded into a lower-dimensional space and can also be used to learn the latent relationship between the context and the computing overhead.

In some examples, an aggregated computing consumption in the edge computing device may be measured, wherein the controller may use the measurement results as a feedback for training an optimization model that learns to determine the RIS configuration parameters that minimize the aggregated computing consumption.

In some examples, the controller may have an application programming interface (API) to an RIS control channel. It may be provided that the controller uses this API to enforce that the RISs deployed within the cell's coverage area switch to the determined RIS configuration parameters. For instance, the controller may be configured to send respective push messages containing the determined RIS configuration parameters over the RIS control channel.

In some examples, it may be provided that the action space theoretically available for the controller is reduced by constraining the RIS configuration parameters, which are eligible to be determined by the controller, to a predefined set of fixed configurations. The eligible configurations may be specified in a RIS specific codebook.

According to an embodiment, the DUs may be deployed using containers that are lightweight and easy to manage, e.g. using container managers such as Docker. In this case, it may be provided that the controller has access to a container manager control API and configures different computing resources, including the computing core set and the computing time for each container, via this API.

In some examples, the vRAN may comprise a service management and orchestrator (SMO) hosting a non-real time RAN intelligent controller (non-RT RIC), e.g. as specified by the O-RAN architecture. In this case, the controller may be deployed as part of the non-RT RIC.

In some examples, in case of multiple RIS being deployed, the control system may comprise a number of different agents that map to each deployed RIS. According to an embodiment, the controller may be configured to use multi-agent reinforcement learning to jointly optimize the RIS configuration of the different deployed RIS to minimize the computing overhead of the deployed DUs.

There are several ways how to design and further develop the teaching of the present disclosure in an advantageous way. To this end, reference is made on the one hand to the following explanation of embodiments of the invention by way of example, illustrated by the figures on the other hand.

Embodiments of the present disclosure relate to RAN virtualization (vRAN) and aim at optimizing the computing consumption in order to reduce the total computing overhead of a vRAN command thereby mitigating the noisy neighbour's problem. Even though isolating the different resources in computing has been a straightforward strategy followed by most operators, other strategies have been deployed that can also effectively mitigate the computing overhead.

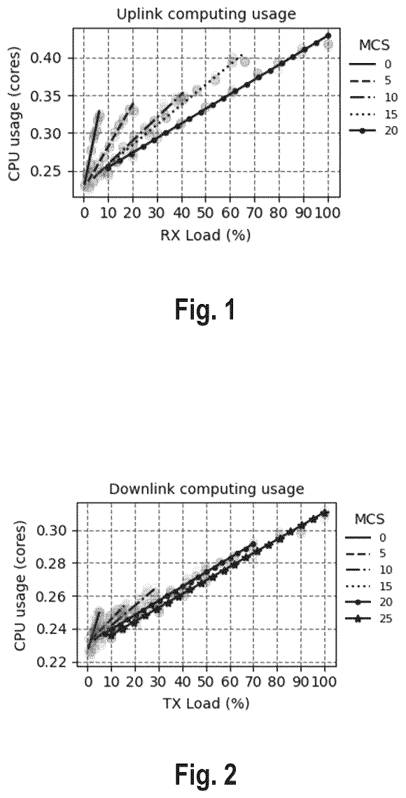

To analyse the underlying problem areas, FIGS. 1 and 2 depict the computing usage consumption of a virtualized Base Stations (vBS) for both uplink (FIG. 1) and downlink (FIG. 2) as a function of the received traffic.

As can be observed, the computing usage depends on the transmitted and received traffic load and the MCS (Modulation and Coding Scheme) configured. A vBS configured with a higher MCS means more information bits are sent using the same number of Physical Resource Blocks (PRBs), while a lower MCS sends fewer bits per PRB. Thus, for the same transmitted or received load, a higher MCS uses fewer PRBs, leading to lower computing usage. The more computing resources a vBS needs to process in the downlink and uplink, the worse the noisy neighbours effect, as the vBS will use more computing cycles for encoding and decoding.

However, the computing workload of a vBS not only depends on the users' network load dynamics, just like in traditional VNFs, but also depends on the signal-to-noise ratio (SNR) of the wireless channel as this sets the maximum eligible MCS, which further depends on the mobility patterns of the users and the dynamics of interfering sources. Higher SNR regimes allow using higher MCSs, enabling PRBs to carry more information bits.

Various examples of the present disclosure are based on the finding that the SNR of the wireless channel can be improved by the deployment of Reconfigurable Intelligent Surfaces (RIS). RIS are a novel tool gaining importance due to the bands' physical characteristics to fulfil the newer technology standards for broadband cellular networks. RISs are typically composed of multiple small antennas that can be individually controlled to manipulate incoming electromagnetic waves. They provide control over the channels between base stations and users, to the point of allowing reflection of the waves from the base station in many useful ways: reflecting in any arbitrary direction (acting as an anomalous reflector), focusing on reduced spots (acting as a lens), or scattering over a wide area. RISs can also reconfigure themselves and dynamically adjust their behaviour to the situation. This allows the operator to follow individual users as they move, change the focus of one or more RISs between users (or groups of users) as traffic load changes, and redefine on the go the areas over which the RIS operates. RIS can provide inhomogeneous coverage to improve signal strength in areas where it is most needed. At the same time, their energy consumption is very low. Furthermore, they can be built in different sizes and can be easily adapted to different surfaces deployed.

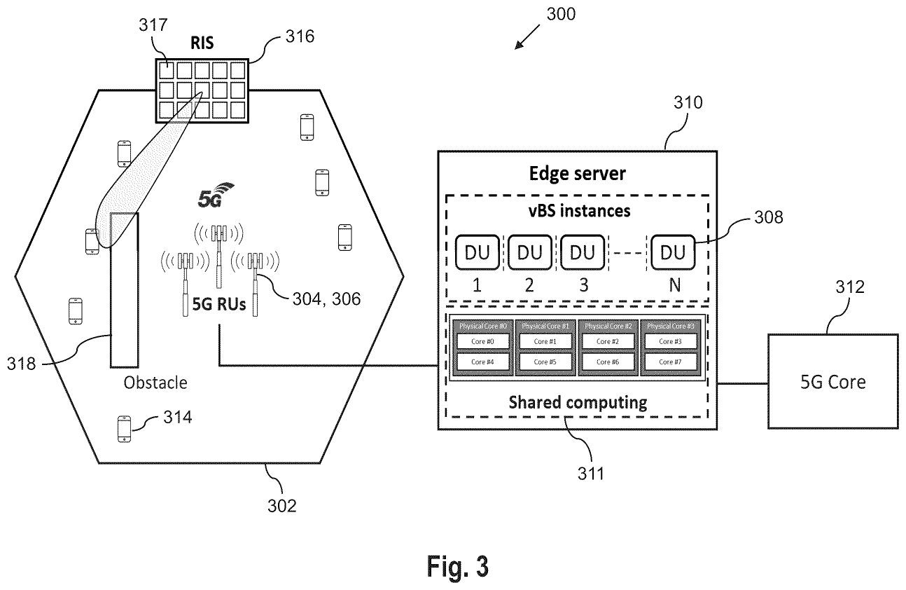

FIG. 3 schematically illustrates an exemplary system model 300 considered in the present disclosure. According to this model, a 5G radio cell 302 is composed of one or multiple vBSs 304, which, following the well-known O-RAN architecture, are functionally split and built up using Radio Units (RUs) 306, Distributed Units (DU) 308 and Central Units (CUs), which are omitted in FIG. 3 for simplicity. As can be assumed to be known, the RU 306 is the radio hardware unit that converts radio signals sent to and from the antenna into a digital signal for transmission over packet networks. It handles the digital front end (DFE) and the lower PHY layer, as well as the digital beamforming functionality. The DU 308 usually runs the radio link control (RLC), medium access control (MAC), and parts of the physical (PHY) layer. The CU usually includes radio resource control (RRC), service data adaptation protocol (SDAP), and packet data convergence protocol (PDCP) layers, and is mainly responsible for non-real-time RRC and PDCP protocol stack functions.

Each RU 306 is connected to the corresponding DU 308, which is deployed into an edge computing server 310, located between the RUs 306 and the 5G core network 312. The DUs 308 deployed into the edge server 310, DU₁, . . . , DU_{N} in FIG. 3, share the available computing resources 311 of the edge server 310.

Further, the radio cell 302 serves different users/user equipment (UEs) 314 (both terms are used interchangeably herein) spread over the coverage area of the radio cell 302 and one or multiple Reconfigurable Intelligent Surfaces (RIS) 316. For the sake of simplification, only a single RIS 316 is depicted in FIG. 3. Generally, RIS can improve the coverage of different users 314 depending on different criteria, for instance users 314 shaded from the RUs 306 by an obstacle 318, as schematically illustrated in FIG. 3. RIS 316 includes an array of reflective elements 317, which are configured to reflect an impinging RF signal and which include an antenna element and means for adjusting the phase shift of the reflected RF signal. Generally, the RIS 316 may be designed according to the concepts described in the document “Reconfigurable Intelligent Surfaces (RIS); Use Cases, Deployment Scenarios and Requirements”, Group Report, ETSI GR RIS 001 V1.1.1 (2023-04), which is hereby incorporated herein by reference.

Embodiments of the concepts disclosed herein are based on the finding that RIS 316 can be used to improve the SNR of different users 314, which in turn may mitigate the effect of the noisy neighbours, decreasing the aggregated computing usage of the edge platform 310.

According to the concepts disclosed herein, it is proposed to leverage the capabilities of RISs 316 to improve the SNR ratio of the different users 314 selectively. Future RISs are often modelled as capable of reconfiguring themselves instantaneously and inexpensively (in energy terms). However, those capabilities are theoretical assumptions and are far from guaranteed in the foreseeable near future. More so, they will likely be unachievable in devices that emphasize both low cost and low energy consumption as primary design concerns. When a RIS takes non-negligible time and energy to reconfigure itself, using it to rapidly switch between individual users, providing maximal gain for each one is no longer possible, and a criterion needs to be established to decide which connections are to be enhanced by the RIS. The immediate option is to cover those users grouped in areas with the lowest SNR. Instead, according to the concepts proposed herein, the RIS capabilities are leveraged to reduce the computing overhead due to resource contentions in scenarios with virtualized resources. In some embodiments, it is proposed to use contextual information about which users are generating the highest traffic loads and which ones share similar channels due to their spatial distribution and to improve selectively the SNR of the users, such that the users can use a higher MCS. A higher MCS would result in the highest decreases in the computing overhead contributing to alleviate the ‘noisy neighbours’ problem. Furthermore, using a higher MCS also reduces the number of PRBs used.

An aspect of the present disclosure relates to the implementation of a controller that configures the phase and gain of the different antennas of the RISs available in a coverage area of a radio cell to decrease the computing overhead of the different vBSs deployed in a shared computing platform mitigating the ‘noisy neighbour’ effect. As already discussed above, FIG. 3 illustrates a scenario where one or multiple RISs 316 give coverage to an area with multiple users 314 using different RUs 306 and DUs 308 deployed into the same edge computing server 310. Thus, depending on its users' location and demands, each DU 308 will have a different computing demand. These demands will require different computing resources, which will set the ‘noisy neighbours’ effect as the shared resources 311 are not entirely ideally isolated. As will be described in detail below, embodiments of the present disclosure provide an AI-driven controller that tries to minimize the total computing overhead due to resource contentions so that the ‘noisy neighbours’ effect impacts the least on the different DUs 308.

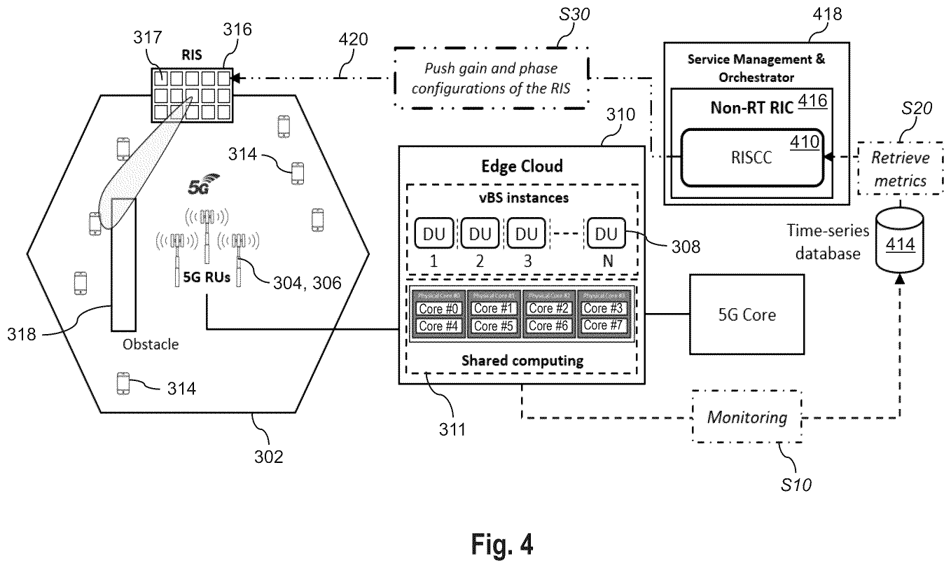

FIG. 4 shows the system model of FIG. 3 and schematically illustrates the integration of a scenario according to embodiments of the present disclosure. In FIG. 4, like reference numbers denote like or similar components as in FIG. 3. Although in FIGS. 3 and 4, the radio cell 302 is illustrated in form of a 5G cell, it is explicitly noted that the present disclosure is not restricted to 5G scenarios, but may be likewise implemented and utilized in different telecommunications networks, e.g. 6G networks or beyond, where similar principles regarding the functional split of the base stations are realized.

The considered scenario is composed of two main parts. First, the scenario includes the edge host 310 (which may be cloud based) where the different DUs 308 are deployed. Each DU 308 is associated with an RU 306, or there may be different DUs 308 sharing the same RU 306. Although, in principle, various deployments are possible, the DUs 308 are deployed here using containers, as they are lightweight and easy to manage. In case of a deployment using containers, container managers such as Docker may be utilized, which enable to easily manage different containers automating their creation, life-cycle management, and removal. Furthermore, they include different mechanisms to allocate computing resources to the deployed DUs 308.

Second, the scenario includes a controller 410, sometimes herein also denoted RISCC (Reconfigurable Intelligent Surfaces Computing Controller), which is configured to optimize the gain and/or the phase of the different RIS elements 317 of the RISs 316 to improve the SNR and, consequently, the MCS of those users 314 that contribute the most to the computing overhead experienced by the different DUs 308. In this context, it may be provided that the edge host 310 includes a metrics agent (not shown in FIG. 4), which is configured to gather and monitor (as shown at S10) different metrics from the DUs 308 and the infrastructure. These metrics may be saved into a metrics database 414. As shown in FIG. 4, the RISCC controller 410 may be deployed in the non-real time RAN Intelligent Controller (RIC) 416 which is hosted by the Service Management and Orchestrator (SMO) 418.

According to an embodiment, the controller 410 may be implemented such that it can reach the edge host 310 and the RISs control plane 420, e.g. through the vBSs 304 deployed. Thus, the RISCC controller 410 can reach at least the following APIs:
The container manager control API in the edge-computing host 310 which enables for managing and orchestrating the deployed containers. The controller can retrieve information from each container running into the platform as well as the controller can configure different computing resources, including the computing core set and the computing time for each container;
The RIS control channel 420 to decide the gain and phase of the different antenna elements 317 of the RISs 316;
An interface to control the L3 cache allocation.

According to embodiments, the controller 410 may be configured to run in discrete time intervals that can be regarded as decision intervals. In case the controller 410 is deployed in the non-real time RIC 416, time intervals of hundreds of milliseconds to seconds would constitute a suitable time-scale for the controller 410 to operate.

At the beginning of each decision interval, the controller 410 may be provided with input data context, and the controller 410 may output a corresponding RIS configuration to optimize the computing consumption of the different DUs 308 deployed in the edge-computing platform 310. The controller 410 may be configured to fetch/retrieve (as shown at S20) different metrics from the metrics database 414, which may be configured to store all the measurement data collected from the edge host computing platform's 310 metrics agent 412.

According to embodiments, the controller 410 may be implemented by means of reinforcement learning techniques which use a feedback signal to learn the latent relationship between the context and appropriate actions (with respect to setting configuration parameters of the RIS 316, e.g. gain and/or phase of the RIS elements 317). However, the controller 410 can also be implemented using other optimization techniques that do not use any feedback signal to constantly learn the optimal actions.

The context, actions, and feedback signal functions of the controller 410 is described in more detail below. Subsequently, an exemplary architecture of the controller 410 is described in detail.

### Context

According to an embodiment, metrics may be collected for each user 314 in the current coverage area of radio cell 302. The respective measurements may be done in large time scales from hundreds of milliseconds to seconds. Based on the collected metrics, a context input vector may be generated that is used as input context vector for the controller 410. For instance, for each user 314, the following information may be collected:
Signal-to-noise ratio (SNR): The current signal-to-noise ratio that a user 314 is experiencing in uplink and downlink. In the uplink, the SNR may be measured by the DUs 308, whereas in the downlink this value can be inferred from the Channel Quality Indicator (CQI);
Traffic demand: Measurements may be taken for the uplink and downlink traffic demands. For instance, this information can be retrieved from the DU 308 that is processing a specific user 314;
Position in the cell: In this context, it may be assumed, for instance, that the DUs 308 have sensing capabilities and can provide an approximate estimation of the position of the associated users 314 inside the cell 302.

The DUs 308 can be configured to save the previous listed metrics into different log files, which can be read by the metric agent deployed in the edge host 310. Thus, after reading the logs, the metrics agent may send the log values to the time-series database 414.

According to an embodiment, the metrics agent may also collect the following infrastructure metrics:
Computing usage: The computing usage of each of the DUs 308 deployed. The timescale for these measurements may be the same as or a bit shorter than in case of the user-related metrics. For instance, the respective measurements may be performed every hundreds of milliseconds.

The metrics agent may be configured to provide all the previous infrastructure metrics also to the metrics database 414, which the controller 410 can access.

According to an embodiment, the controller 410 may be configured to fetch the previous data from the metrics database 414 (as shown at S20) and to process the retrieved data to create a contextual vector that will serve as input to an optimization model. Using history samples of each user 314, the controller 410 may predict the probability distribution of the SNR, traffic demand, and position for future decision intervals. Using the predicted probability distributions, the controller 410 may compute the distributions' different moments, namely the mean, variance, skewness, and kurtosis. Based thereupon, the controller 410 may construct a vector for each user 314, wherein the values of the vector are the moments of the previously computed probability distribution. As there can be a varying number of users 314 in the cell, the different user vectors may be embedded in a fixed dimension space. This can be done, e.g., using a Relation Network (RN), but other context-embedding techniques can also be applied. More details will be provided below on the description of the functional blocks.

In another embodiment, instead of using metrics from the different users 314, it may be provided to leverage probes deployed by operators at different locations. This embodiment may take advantage of the fact that sometimes operators collect and monitor mobile traffic using specialized probes that have been installed at various points within the network structure. Using these probes, the cell area can be divided into smaller areas. For each of these smaller areas, the probability distribution of different parameters, such as the aggregated traffic demand and SNR, may be predicted using historical data. This information can also be used as input to an optimization model of the controller 410. Similarly to the previous embodiment, a contextual vector with different moments of the predicted probability distribution can be generated for each small area and the different vectors can be embedded in a fixed lower dimensional space.

### Actions

The controller 410 may be configured to take different actions in the system. According to an embodiment, these actions may include deciding the gain and phase of the antenna of each RIS element 317 of the RISs 316 within and/or around the cell's 302 coverage area.

With regard to the gain, it is noted that the gain can take two different values, namely the antenna is either powered on or entirely switched off. With regard to the phase, it is noted that each antenna can be configured with varying values of phase, e.g. 4 different values. As RIS can be composed of many antenna elements, typically 64, there is a plurality of possible configuration combinations (e.g., with the given figures, 2×4×64=512). Therefore, according to an embodiment, it may be provided that the set of possible actions is constrained to a set of fixed configurations for all the antennas to reduce the action space. That is, the action space is discrete and contains different RIS configurations. In other words, each RIS 316 may have a codebook of a fixed number of predefined configurations, and the controller 410 will select which of these predefined configuration will be active. The controller 410 may push the determined gain and phase configurations to the respective RIS 316 via the RIS control channel 420, as shown at S30 in FIG. 4.

### Reward

With respect to the optimization model utilized by the controller 410, it may be provided that the controller 410 uses a global reward function to optimize the system computing overhead. Thus, the less aggregated the computing consumption, the less relevant the effect of the noisy neighbour's problem will be. Whenever the controller 410 decides on the RISs configurations, the aggregated computing consumption in the edge host 310 may be measured and those measurements may be used as a feedback signal that the controller 410 receives, such that the controller 410 constantly learns the relationship between the actions and the computing overhead. According to an embodiment, the main goal of the controller 410 may be minimizing the aggregated computing consumption.

### Optimization Parameters

The function to be optimized can be adapted to the needs and characteristics of each scenario. Generally, it is noted that the noisy neighbors problem forces the system to use significant (and costly) additional computational resources. Using the available RISs to mitigate the noisy neighbors problem can potentially lead to a reduced need of processing power in the BSs as improving the SNR leads to using less radio resources and having less IQ samples to process, and therefore reducing the computational power needed. This need of computational power can be translated into economical cost in an optimization function, e.g., as follows:

In a typical scenario envisioned by the concepts of the present disclosure, the presence of several resources i (such as GPUs, CPUs, local, edge and cloud computing resources, etc.) in the shared computing resources 311 of the edge server 310 is considered. Hereinafter, the usage of a resource i is denoted as rᵢ. Energy and other OPEX costs associated with the computing resources will be taken into account in a purely economical translation of costs per second per full use of the computing resources aᵢ. This portion of the equation may be substituted by an appropriate pricing schema in scenarios where the resources are obtained from an external source. Increasing the usage of a resource also contributes to a possible need of installing additional resources, and this probability increases with the fraction uᵢ of the resources being currently used. This value would be the same as rᵢ in the scenarios where there are no shared resources, and zero if the resources are obtained from an external source and the operator would not incur in additional CAPEX to deploy additional capacity. This cost is denoted as bi. Accordingly, an optimization function of the controller 410 that represents the costs of the computational resources needed may be set as follows:

$$Optimization Function = {min}_{c ∈ C} \{ {\sum }_{∀ i} ( {r}_{i} \cdot {a}_{i} + {r}_{i} \cdot {u}_{i} \cdot {b}_{i} ) \}$$

where c denotes the evaluated RIS configuration and C is the space of possible RIS configurations. The technical dimensions of the above cost reduction include computational power, processing power, and radio resources.

If the following constraints are not fulfilled, the value of the optimization function fed to the agent for learning purposes, i.e. to the controller's 410 optimization model that learns to evaluate the RIS configuration parameters that minimize the aggregated computing consumption, may be set to zero.

The constraints can also be tailored for each scenario. For instance, it may be assumed a minimum acceptable SNR for a user, denoted SNRₘᵢₙ, and a high threshold, denoted SNRₘₐₓ, which marks the point where additional gains in SNR do not have any positive impact in the communication channel. Users 314 that, due to the application of the concepts disclosed herein, see their SNR above the SNRₘₐₓ should not be taken into account, regardless of SNR decreases. Users below there should be protected against SNR losses, e.g. by setting a minimum SNR after the application of the concepts disclosed herein of a fraction 0<P<1 (e.g. P=0.9) of the margin above the SNRₘᵢₙ threshold that was available before. Accordingly,

$${SNR}_{j} - {SNR}_{pj} \geq ( 1 - P ) \cdot ( {SNR}_{j} - {SNR}_{min} ) ∀ j where$$

$${SNR}_{j} < {SNR}_{max} and {SNR}_{pj} \geq {SNR}_{min}$$

where SNR is the SNR of a user j with the usage of the concepts disclosed herein (i.e. with RIS configurations set according to the controller's 410 evaluation), and SNRₚⱼ is the SNR of the user j without the usage of the concepts disclosed herein (i.e. with RIS configurations not set according to the controller's 410 evaluation, e.g. arbitrary RIS configurations).

The parameters of the optimization may be the configuration of the RISs 316 used in the network, either directly by individual control of the phase shifts and/or amplification of the elements 317 of the RISs 316, or indirectly (e.g. by determining the association of the RISs 316 to the users 314 or the direction and shape of the beam pattern of the RISs 316).

According to an embodiment, the present disclosure provides a method of operating a virtualized radio access network, vRAN, wherein the method comprises the following steps:
(1) Fetching the previous listed metrics for each user 314 in the coverage area and the infrastructure metrics from the edge computing host 310;
(2) Computing the optimal configuration parameters of the different RIS 316 to minimize the computing consumption; and
(3) Enforcing the RIS configuration through the control APIs so that all the RIS 316 covering the area update their configurations accordingly.

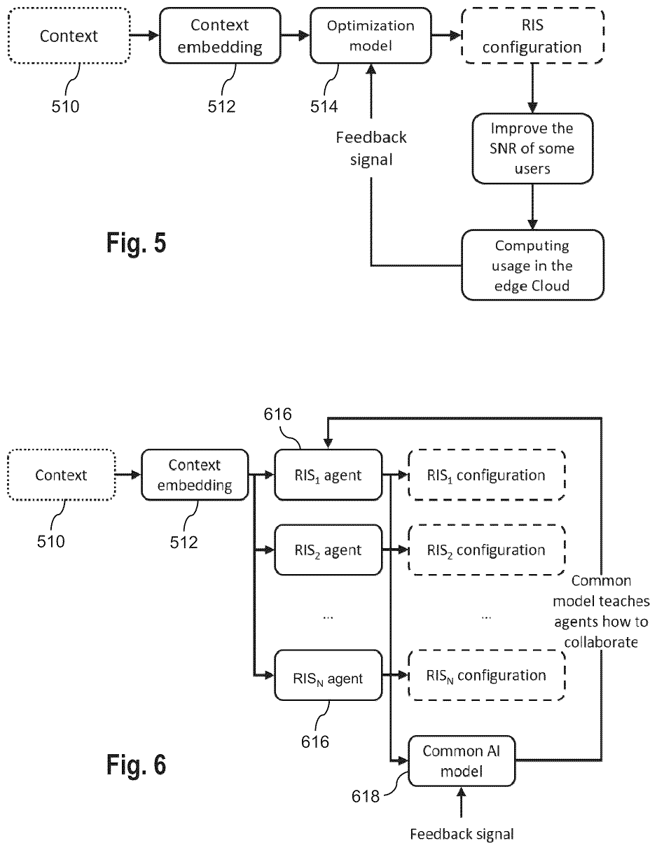

FIG. 5 is a diagram illustrating the different functional blocks of a RISCC controller 410 according to an embodiment of the present disclosure when there is only a single RIS 316 deployed with the cell's 302 coverage area. In this case, the controller 410 may be implemented using a context embedding function 512 and an optimization model 514. For example, to implement the context embedding, the controller 410 can use a relation network to handle the variable input context 510. Specifically, the context-embedding function 512 may be configured to embed the input context 510 into a fixed dimension space. For the optimization model 514, the controller 410 can use common reinforcement learning algorithms, such as Deep Q-Network (DQN). Using the previously mentioned feedback function, the optimization model 514 will learn to select the RIS configurations that minimize the aggregated computing consumption.

FIG. 6 is a diagram illustrating the different functional blocks of a RISCC controller 410 according to an embodiment of the present disclosure when there are two or more RIS 316 (RIS 1, . . . , N in the illustrated embodiment) deployed with the cell's 302 coverage area. In this case, the (AI driven) controller 410 may be implemented using different RIS agents or models 616, wherein each RIS agents 616 is directly mapped to a RIS 316 involved. An implementation example would encompass using multi-agent reinforcement learning approach. As a cell 302 can serve a variable number of users 314, it is crucial that the controller 410 embeds the input context 510 to a fixed length context. In an example, the context embedding may be implemented using a relation network (RN).

Each RIS model 616 will choose the corresponding actions for the RIS 316 to which it is mapped. Furthermore, each RIS model 616 may be configured to collaborate and learn with the other RIS 316 so that it is possible to minimize the computing consumption. Specifically, once all the agents 616 have computed the different actions per RIS 316, the controller 410 may use a common model 618 to teach each RIS agent/model 616 how to collaborate selecting the best configuration to minimize the computing overhead. As explained before, the aggregated computing usage in the edge computing device 310 may be used as the main minimization goal to train the common model 618.

Many modifications and other embodiments of the invention set forth herein will come to mind to the one skilled in the art to which the invention pertains having the benefit of the teachings presented in the foregoing description and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of operating a virtualized radio access network; (vRAN), wherein a radio cell of the vRAN comprises one or more virtualized base stations (vBSs) serving a number of users located within a coverage area of the radio cell, and at least one reconfigurable intelligent surface (RIS), and wherein the vBSs include radio units (RUs) and distributed units (DUs), wherein each RU is associated with at least on DU, and wherein the DUs are deployed in an edge computing device sharing the computing device's available computing resources, the method comprising:
determining, using a controller, configuration parameters of the at least one RIS in terms of gain and/or phase of reflective elements of the RIS that minimize a computing overhead of the DUs deployed in the edge computing device.

2. The method according to claim 1, further comprising, by the controller:
determining, by using contextual information about the users, which of the users are generating highest traffic loads and/or which of the users share similar channels due to their spatial distribution within the coverage area of the radio cell; and
setting the configuration parameters of the at least one RIS to improve selectively a signal-to-noise ratio (SNR) of the respective users.

3. The method according to claim 1, further comprising:
generating, by the controller for each user located in the coverage area of the radio cell, a context vector based on metrics collected for a respective user, wherein the metrics include at least one of:
a current signal-to-noise ratio the respective user experiences in uplink and in downlink,
traffic demands of the respective user, and
the position of the respective user within the radio cell.

4. The method according to claim 1, further comprising:
generating, by the controller, a context vector based on contextual information retrieved from monitoring probes deployed in the radio cell's coverage area.

5. The method according to claim 3, further comprising:
embedding, by the controller, the context vector into a fixed dimension space; and
using, by the controller, the contextual information of the context vector as input to learn a latent relationship between a context and the computing overhead of the DUs deployed in the edge computing device.

6. The method according to claim 1, further comprising:
measuring an aggregated computing consumption in the edge computing device; and
using, by the controller, measurement results of the measuring as a feedback for training an optimization model that learns to determine the RIS configuration parameters that minimize the aggregated computing consumption.

7. The method according to claim 6, further comprising:
enforcing, by the controller via an application programming interface (API) to an RIS control channel, that the RISs deployed within the radio cell's coverage area switch to the determined RIS configuration parameters.

8. The method according to claim 1, further comprising:
reducing an action space for the controller by constraining the RIS configuration parameters that are determined by the controller to a predefined set of fixed configurations.

9. The method according to claim 1, further comprising:
deploying the DUs using containers; and
configuring, by the controller, different computing resources, including a computing core set and a computing time for each container via a container manager control application programming interface (API).

10. A control system in a virtualized radio access network (vRAN), wherein a radio cell of the vRAN comprises one or more virtualized base stations (vBSs) serving a number of users located within a coverage area of the radio cell, and at least one reconfigurable intelligent surface (RIS), and wherein the vBSs include radio units (RUs), and distributed units (DUs), wherein each RU is associated with at least on DU, and wherein the DUs are deployed in an edge computing device sharing the computing device's available computing resources, the control system comprising:
a controller that is configured to set configuration parameters of the at least one RIS in terms of gain and/or phase of reflective elements of the RIS that minimize a computing overhead of the DUs deployed in the edge computing device.

11. The control system according to claim 10, wherein the vRAN comprises a service management and orchestrator (SMO) hosting a non-real time RAN intelligent controller (non-RT RIC), and wherein the controller is deployed in the non-RT RIC.

12. The control system according to claim 10, further comprising a metrics agent deployed on the edge computing device, wherein the metrics agent is configured to gather a predefined set of different metrics from the DUs and/or the users and to save the gathered metrics into a metrics database.

13. The control system according to claim 10, wherein, in case of multiple RISs being deployed, the controller includes a number of different agents that map to each deployed RIS, wherein the controller is configured to use multi-agent reinforcement learning to jointly optimize an RIS configuration of different deployed RISs to minimize the computing overhead of the deployed DUs.

14. The control system according to claim 10, further comprising:
monitoring probes deployed in a coverage area of the radio cell, the monitoring probes being configured to provide the controller contextual information about an area within the coverage area of the radio cell where different DUs give coverage.

15. The device according to claim 10, wherein the DUs are deployed using containers, and wherein the controller has access to the containers via a container manager control application programming interface (API).
